(19) United States
(12) Patent Application Publication
(10) Pub. No.: US 2026/0272228 A1
(43) Pub. Date: Sep. 17, 2026

(54) BLENDING CONTAINER

(71) Applicant: VITA-MIX MANAGEMENT CORPORATION, Olmsted Township, OH (US)

(72) Inventors: Stephen Hosey, Olmsted Township, OH (US); Brad Paskert, Olmsted Township, OH (US); John Chancey, Olmsted Township, PA (US)

(73) Assignee: VITA-MIX MANAGEMENT CORPORATION, Olmsted Township, OH (US)

(21) Appl. No.: 19/472,955

(22) PCT Filed: Apr. 10, 2024
(86) PCT No.: PCT/US2024/023924

§ 371 Date: Oct. 6, 2025

Related U.S. Application Data
(60) Provisional application No. 63/458,297, filed on Apr. 10, 2023.
(60) Provisional application No. 63/583,548, filed on Sep. 18, 2023.

(51) Int. Cl. A47J 43/046; A47J 43/07; A47J 43/08; B01F 27/808; B01F 27/90; B01F 101/00

(52) U.S. Cl. CPC A47J 43/046; A47J 43/0722; A47J 43/0727; A47J 43/085; B01F 27/808; B01F 27/90; B01F 2101/1805

(57) ABSTRACT

A blending system having a base, a blending container removably coupled to the base, and a blade assembly coupled to the body is disclosed. The blending container includes a body having a first end defining an opening, a second end defining a bottom surface, and an interior wall extending between the first end and the second end. The body further has a rib projecting from the interior wall toward a center of the blending container, a channel defined in the interior wall adjacent the rib, and a ramp extending between the bottom surface and the channel defined in the interior wall. The blade assembly is coupled to the body at a blade height from the bottom surface of the body.

### CROSS REFERENCE TO RELATED APPLICATIONS

The present application claims priority to and the benefit of U.S. Provisional Application No. 63/458,297, entitled BLENDING CONTAINERS WITH RIBS, and filed on Apr. 10, 2023, the entire contents of which are hereby incorporated by reference. The present application further claims priority to and the benefit of U.S. Provisional Application No. 63/583,548, entitled EFFICIENT BLENDER CONTAINER, and filed on Sep. 18, 2023, the entire contents of which are hereby incorporated by reference.

### TECHNICAL FIELD

The present disclosure generally relates to blender systems, and more specifically, to blender systems with optimized blending containers for more efficient and/or effective blending of food products.

### BACKGROUND

Blender systems are used to blend and process a variety of food products. Conventional blenders generally include a blender base and a blending container with a blade assembly therein. The properties of a blending container can have a significant impact on both the quality of a blender's food processing as well as the speed at which a blender can effectively process food products. Inefficient blender system designs can produce dead zones within a blending container that may inhibit efficient, uniform blending of the blend media.

Given the wide variety of uses for blenders and different environments in which they may be used, the long blending times can be impractical and can decrease efficient use of the blending systems. Therefore, a need exists for improved systems and methods for reducing the blending time of a blending process while still providing a consistent and well-blended product.

### SUMMARY

The following presents a summary of this disclosure to provide a basic understanding of aspects. This summary is intended to neither identify key or critical elements nor define any limitations of embodiments or claims. This summary may provide a simplified overview of some aspects that may be described in greater detail in other portions of this disclosure. Furthermore, any of the described aspects may be isolated or combined with other described aspects without limitation to the same effect as if they had been described separately and in every possible combination explicitly.

A blending container comprising a body and a blade assembly coupled to the body is disclosed. The body comprises a first end defining an opening, a second end defining a base, and an interior wall extending between the first end and the second end. The body further comprises a rib projecting toward a center of the blending container, the rib extending a first length of the interior wall from the base toward the first end, a channel defined in the interior wall adjacent the first rib, and a ramp extending between the base and the channel defined by the interior wall. The blade assembly is positioned at a blade height from the base of the body, and the ramp is shaped to minimize a distance between the body and a surface of the blade assembly facing the base.

A blending system comprising a base, a blending container removably coupled to the base, and a blade assembly coupled to the body is disclosed. The blending container comprises a body comprising a first end defining an opening, a second end defining a bottom surface, and an interior wall extending between the first end and the second end. The body further comprises a rib projecting from the interior wall toward a center of the blending container, a channel defined in the interior wall adjacent the rib, and a ramp extending between the bottom surface and the channel defined in the interior wall. The blade assembly is coupled to the body at a blade height from the bottom surface of the body.

The following description and the drawings disclose various illustrative aspects. Some improvements and novel aspects may be expressly identified, while others may be apparent from the description and drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 provides an illustrated top-down view of a blending container and blend ribs according to one or more aspects shown and described herein.

FIG. 2 provides an illustrated top-down view of the blending container depicting a clearance between the blend rib and a blade assembly and depicting a flat face of the blend rib according to one or more aspects shown and described herein.

FIG. 3 provides a cross-sectional illustration from within the blending container depicting a distance between a blade tip and a blend rib according to one or more aspects shown and described herein.

FIG. 4 provides a cross-sectional illustration from within the blending container depicting a distance between a blade tip and the base of a ramp according to one or more aspects shown and described herein.

FIG. 5 provides a cross-sectional illustration depicting a flow of blend media along one of the ramps during operation of the blender system according to one or more aspects shown and described herein.

FIG. 6 provides an illustrated depiction of a base of the blending container according to one or more aspects shown and described herein.

FIG. 7 provides an illustrated top-down view of a blending container and blade according to one or more aspects shown and described herein.

FIG. 8 provides an illustrated perspective view of a blending container and blade according to one or more aspects shown and described herein.

FIG. 9 provides an illustrated top-down view of a blending container and blade according to one or more aspects shown and described herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made to exemplary embodiments, examples of which are illustrated in the accompanying drawings. It is to be understood that other embodiments may be utilized and structural and functional changes may be made. Features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality. It is further noted that while various embodiments refer to a blender or a blender system, various other systems may be utilized in view of embodiments described herein. For example, embodiments may be utilized in food processor systems, mixing systems, hand-held blending systems, various other food preparation systems, and the like. As such, references to a blender, blender system, and the like, are understood to include food processor systems, and other mixing systems.

Such systems generally include a blender base that can include a motor, a controller, a display, a memory, and/or a processor. Further, such systems may include a blending container and a blade assembly. The blade assembly, the blending container, and the blender base may removably or irremovably attach. The blending container may be powered in any appropriate manner, such as, for example, via a motor or the like. More specifically, blending systems may have a power source positioned in the blending system at any appropriate location. By way of a non-limiting example, the power source may be positioned in a body of the blending container, in a handle of the blending container, or in a base of the blending system. The power source is to provide power to one or more components of the blending system, such as the controller and/or the motor, for example. The power source can be of any appropriate type—including, for example, an energy storage device, such as a battery. In such instances, the battery can be a rechargeable battery, a regenerative battery, and/or a non-rechargeable battery. For those instances in which the battery is a rechargeable battery, the battery may be charged by the blender base or by an external charging stand.

Blenders and blending systems are often used to blend and process foodstuffs. Frozen, frosty, or icy drinks have become increasingly popular. Such drinks include the traditional shakes, and the more recently popular smoothies. Shakes, or milk shakes, are typically formed of ice cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers.

Smoothies tend to be healthier, and may be formed of ice, frozen yogurt, and/or sorbet. Smoothies may include additives such as fruits, fruit juice, vegetables, vitamins, supplements, etc. Smoothies typically are available from specialty chains or juice bars, and may be made with commercial or restaurant-grade blenders. Such drinks also may be made at home, using a personal blender. Other types of foodstuff may be processed using commercial or personal blending machines and systems, including soups, purees, butter (nut), dips or the like.

Foodstuff may be added to the blending container. Furthermore, while blending of “ingredients,” “contents” or “foodstuffs” is described in various embodiments, it is noted that non-food stuff may be mixed or blended, such as paints, epoxies, construction material (e.g., mortar, cement, etc.) by the disclosed blending systems, and the like. Additionally and/or alternatively, the various blending containers described herein may be utilized to blend non-food stuff in non-food preparation scenarios such as in medical and/or laboratory environments, for example. Further, the blending systems may include any household blender and/or any type of commercial blending system, including those with covers that may encapsulate or at least partially encapsulate the blending container. Further, commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

As used herein, the phrases “blending process,” “blending program,” and the like are used interchangeably unless context suggests otherwise or warrants a particular distinction among such terms. A blending process may include a series or sequence of blender settings and/or operations to be carried out by the blending device. In an aspect, a blending process may include at least one motor speed and at least one time interval for the given motor speed. For example, a blending process may include a series of blender motor speeds to operate the blender blade at the given speed, a series of time intervals corresponding to the given motor speeds, and other blender parameters and timing settings. The blending process may further include a ramp-up speed that defines the amount of time the motor takes to reach its predetermined motor speed. The blending process may be stored on a memory and recalled by or communicated to the blending device.

Blending of foodstuff or ingredients results in a blended product. Such blended products may include drinks, frozen drinks, smoothies, shakes, soups, purees, sorbets, butter (nut), dips or the like. It is noted that various other blended products may result from blending ingredients. Accordingly, terms such as “blended product” or “drink” may be used interchangeably unless context suggests otherwise or warrants a particular distinction among such terms. Such terms are not intended to limit any possible blended products and should be viewed as examples of possible blended products.

Described herein are systems and methods for reducing the blending time to achieve a blended product. Described herein are blending containers that include one or more ribs. The described systems and methods may reduce blending time while providing the same, consistent end product.

Described are blending containers that can achieve about a 50% blend time reduction. Described is a blade and blade assembly. In an example, a typical blend may require a 12 second blend time and the described blending containers, blades and blade assemblies, and/or blending systems may be able to provide the same blending in about 6 seconds—a 50% reduction.

Embodiments of the present blender systems include a blender base and a blending container operatively attachable to the blender base with a blade assembly disposed therein. The blending container includes walls that define an interior cavity containing the blade assembly. The walls of the blending container include one or more blend ribs and/or one or more ramps, which direct the flow of the blend media and optimize the blending performance. The particular shapes and sizes of components, particularly the walls of the blending container, the blend ribs, the ramps, and the blades, are formed so as to address a need for improved blending container designs to improve blend performance and efficiency. That is, the particular designs described herein result in an improved blending of blend media and realizes efficiencies in a blending process relative to conventional designs.

In addition, the blender systems described herein include a lid that may be operatively and/or removably attached to the container to enclose the interior cavity defined by the walls. The blending container may further include a handle. Blend media is intended to be contained within the interior cavity of the container for blending. The blending container can be formed from one or more materials such as, but not limited to, plastics, glass, metals, or the like. In another aspect, the blade assembly within the blending container may be powered in any appropriate manner, such as by components within the blender base, as described herein.

In some embodiments, the blade assembly is attached to a plate insert that is disposed within the blending container. More specifically, a blending container can include a reinforced bottom, or base, to allow for improved performance, user of additional motor parameters, user of different blade assemblies, and/or the like. For instance, the blending container may include increased lifespans and may be capable of handling increased speed or torque from motors. In embodiments, the bottom may be reinforced via a plate insert, such as an overmolded plate insert or the like. The plate insert may include metal or another material that is different from the material of the blending container, such as rubbers, foams, or plastics having a greater creep resistance than the material used for the blending container. In various instances, at least a portion of the plate insert is exposed. The exposed portion may include an aperture that receives a blade assembly. The blade assembly is to be secured into place and/or compressed against or with the exposed portion of the plate insert. The blade assembly may be secured via a retainer nut or the like. The plate insert may improve or increase the strength of the blending container relative to blending containers without a plate insert. In an aspect, the exposed portion of the plate insert may serve as the only component or one of the components of the blending container under compressive force due to attachment of the blade assembly. In another aspect, the plate insert may contact the blade assembly to absorb stress or vibrations. This may prevent or reduce stress on other portions (e.g., plastic portions) of the container Reduced vibration may reduce or prevent container breakage and/or bearing failure.

The blender base includes a motor disposed within a housing. The motor selectively drives the blade assembly when the blade assembly is interfaced with the blender base. As a result, the blade assembly may agitate, impart heat, or otherwise interact with contents within the interior cavity of the blending container. The blade assembly may be a fixed blade system or a variable blade assembly that can be removed between uses.

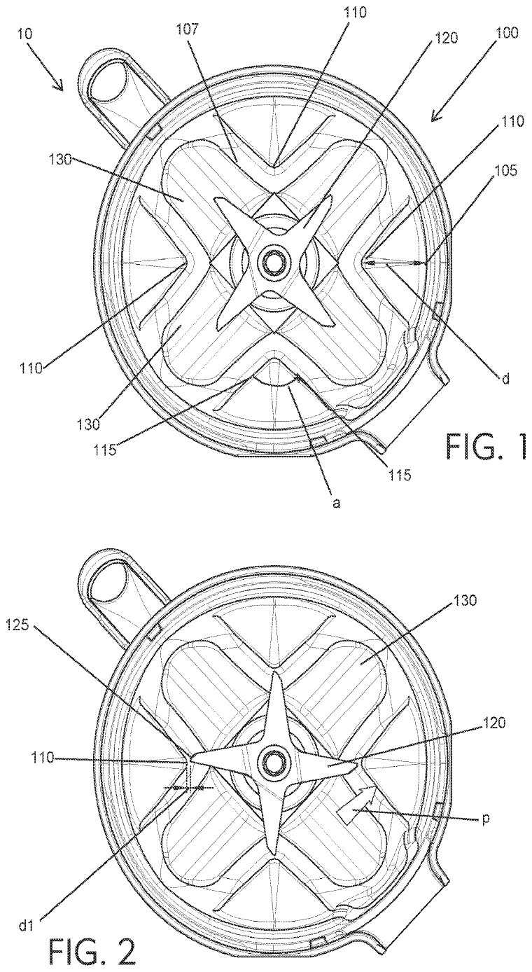

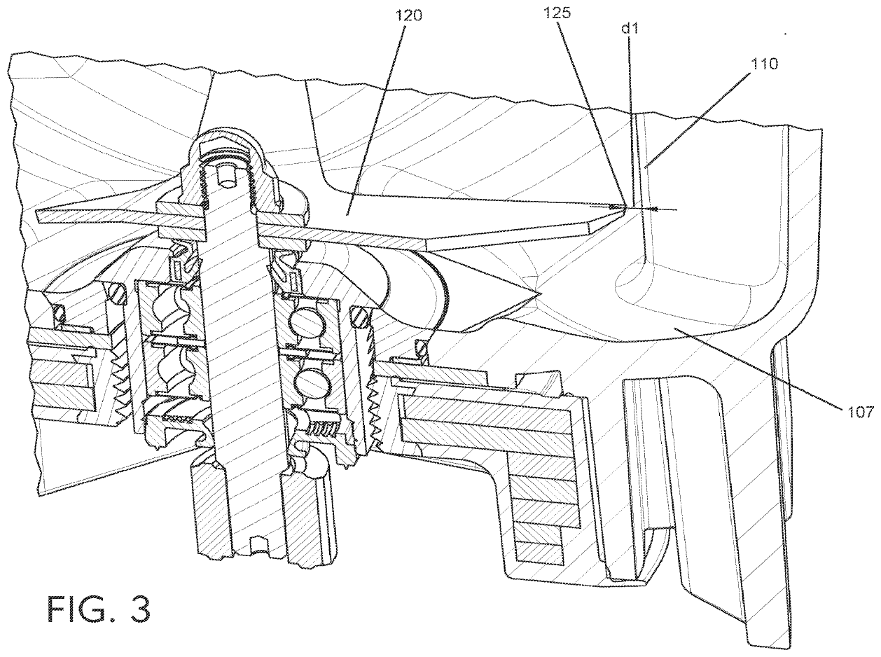

The blending container 100 of a blending system 10 holds blend ingredients and facilitates contact of the blend media with the rotating blade assembly. As depicted in FIG. 1, an interior of the blending container 100 includes a plurality of blend ribs 110 positioned along an perimeter of the blending container. In some embodiments, the blend ribs 110 each extend inwardly a distance d, such as about 1.15 inches, from an interior wall 105 of the blending container 100 and have a wedge geometry as depicted in FIG. 1. Faces 115 of the blend ribs 110 protrude from the interior wall 105 of the blending container 100 and converge to form an angle a of about 100 degrees. The wedge geometry of each of the blend ribs can be widest along its horizontal axis nearest to the interior wall 105, or at a location of the blending container 100 that is furthest from a center of the blending container 100. The geometry of each of the blend ribs can be thinnest at its point nearest to the blade assembly 120. Stated another way, a width of the blend ribs tapers, or otherwise decreases, as the projection extends closer toward a center of the blending container. Each of the plurality of ribs includes one or more faces 115. In various instances, the faces 115 are planar while in other instances the faces 115 are curved. The faces 115 can include a combination of both planar and curved surfaces, for example. Each face 115 creates a region that maximizes interaction between the blend media and the blade assembly 120, improving blending efficiency by creating regions along the blend ribs 110 that collect blended media that has been thrown from the blade assembly 120. The geometry of the faces 115 serves to direct the blended media back toward the blade assembly 120 to initiate subsequent blending. As shown in FIG. 2, in some instances, the blend ribs 110 may be positioned such that the distance d₁ between a tip 125 of the blade assembly 120 and each blend rib 110 is optimized. As the blade assembly 120 spins, the tip 125 of each blade in the blade assembly has an optimized clearance distance d₁ from each of the blend ribs 110 as depicted in FIG. 2. The clearance distance d₁ between the blade assembly 120 and the blend ribs 110 may be optimized so that, during operation of the blending system, blend media is prevented, minimized, or otherwise obstructed, from passing between a blend rib 110 and the blade assembly 120 without interacting with the blade assembly, further maximizing blending efficiency by ensuring interaction between blend media and the blade assembly 120. In at least one embodiment, as shown in FIG. 3, the distance d₁ between the tips 125 of the blade assembly 120 and each of the blend ribs 110 is about 0.07 inches to optimize blending performance.

The blend ribs 110 are not limited to any particular geometry and should be understood to vary in size and shape corresponding to the dimensions of both the blending container and the blade assembly 120 disposed within the blending container 100. Any dimensions detailed herein apply to only one non-limiting embodiment, and other dimensions are contemplated and included within the scope of the disclosure.

The plurality of blend ribs 110 extend along a length of the wall 105 of the blending container 100 extending between a first end and a second end. The first end of the blending container defines an opening to receive blend media therethrough. In various instances, a blend rib 110 from the plurality of blend ribs 110 spans a length that corresponds to a length of the interior wall 105 of the blending container 100. Stated another way, the blend rib 110 extends the entire length of the interior wall 105. The interior wall 105, first end, and second end define a body 102 of the blending container 100. In other instances, the blend rib 110 extends a length from a bottom surface 107 of the blending container 100 toward the first end of the blending container, but not entirely to the first end. In such instances, the blend rib 110 does not extend the entire length of the interior wall 105, but rather extends along a portion of the length of the interior wall 105. In some instances, the plurality of blend ribs 110 extend along the same lengths of the blending container, while in other instances, the plurality of blend ribs 110 extend along varying lengths of the blending container 100.

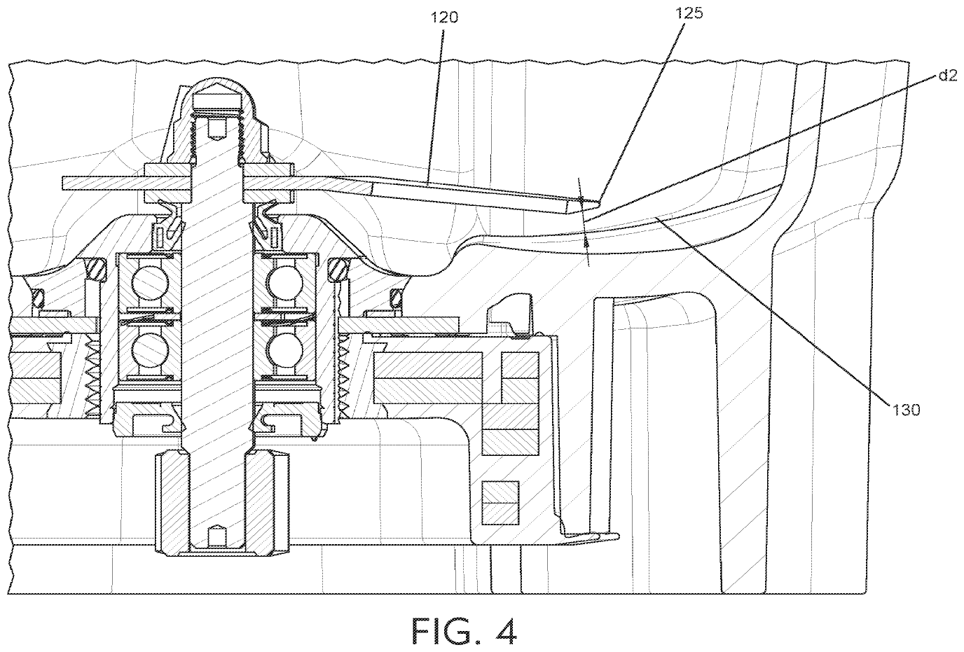

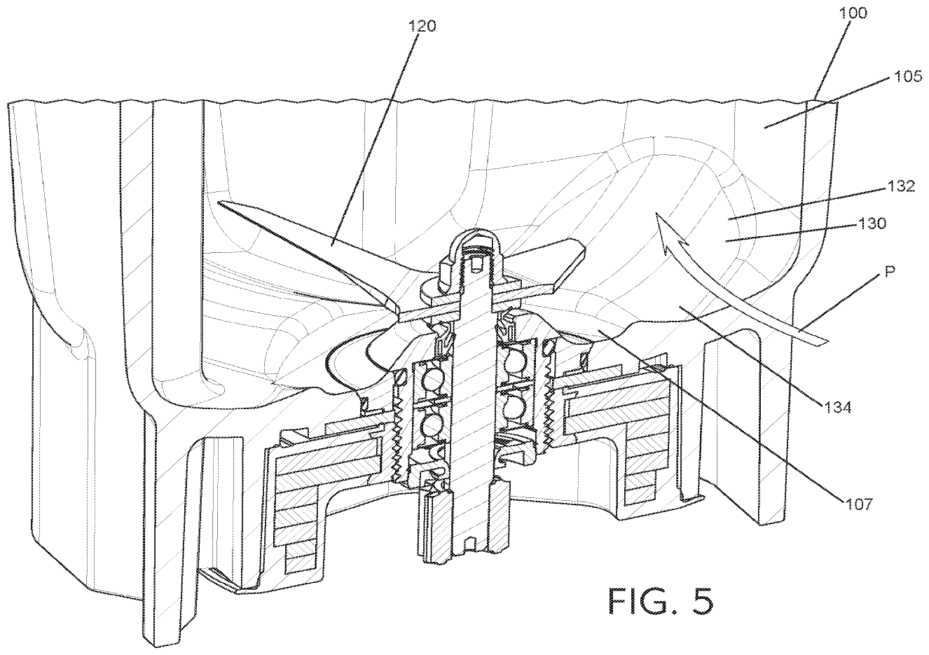

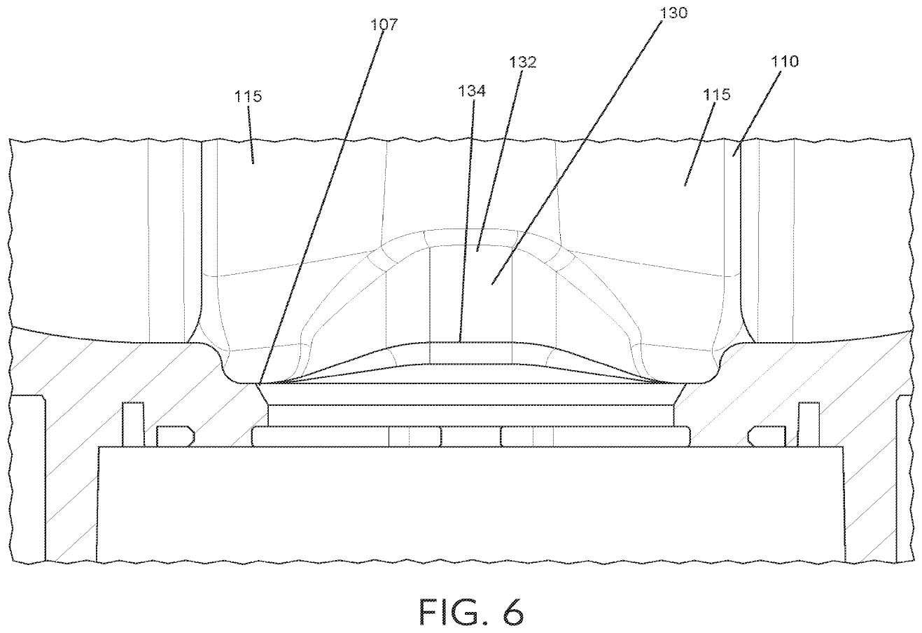

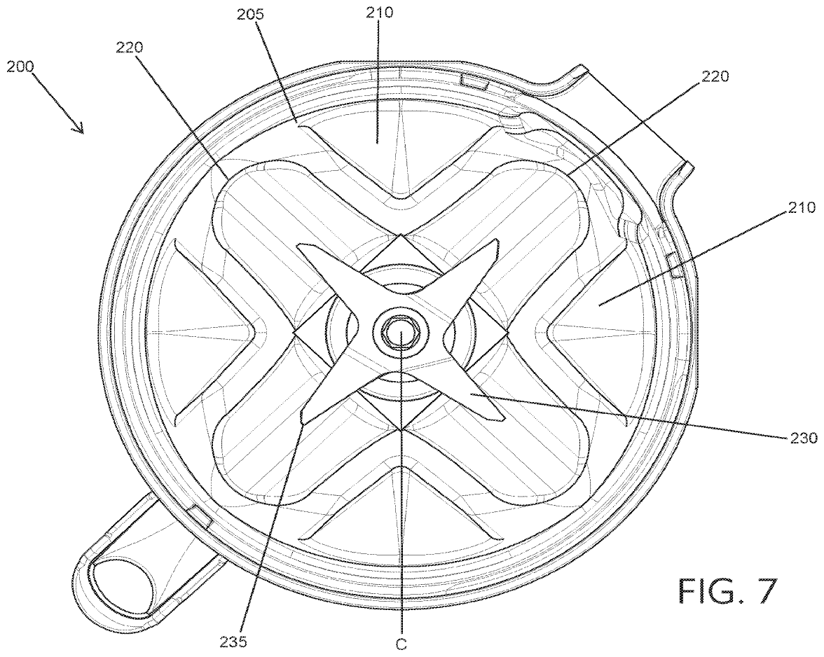

The blending container 100 also includes a plurality of ramps 130 that are positioned along the bottom surface 107 and interior wall 105 of the blending container, which minimize the distance between the edges, or perimeter, of the container and the blade assembly. As depicted in FIG. 4, the vertical distance d₂ between a surface of the tips 125, such as the surface of a blade facing the bottom surface 107 of the blending container 100, of the blade assembly 120 and the base of each of the ramps 130 may be optimized to achieve a minimal clearance distance d₂ so that, during operation of the blending system, blend media is prevented, minimized, or otherwise obstructed, from passing between the base of any of the ramps 130 and the blade assembly 120 without interacting with the blade assembly 120, further maximizing blending efficiency by ensuring interaction between blend media and the blade assembly 120. In at least one embodiment, as shown in FIG. 4, the distance d₂ between a surface of the tips 125 of the blade assembly 120 and each of the ramps 130 is about 0.095 inches to optimize blending performance. As depicted in FIGS. 5 and 6, each of the ramps 130 is positioned between two of the blend ribs 110. The ramps 130 have a concave shape, with a vertical slope at its highest furthest up the container's interior wall 105 and gradually decreasing as the ramp approaches the bottom surface 107 of the container 100. Stated another way, a vertical slope of the ramp is greatest at a first position 132. The first position 132 of the ramp 130 is at the ramp's greatest vertical distance from the bottom surface 107 of the blending container 100. The vertical slope of the ramp decreases, or tapers, as the vertical distance to the bottom surface 107 of the container 100 decreases. For example, a vertical slope of the ramp 140 at a first position 132 is greater, or steeper, than a vertical slope of the ramp 140 at a second position 134. The geometry of the ramp 130 is intended to direct the flow of the blend media throughout the blending container during blending by minimizing the distance between the container's interior perimeter and the blade assembly, as well as eliminating dead zones that would prevent uniform blending. In some embodiments, the ramps 130 are angled, such that blend media is directed toward the blade assembly 120 and the planar faces 115 of the blend ribs 110 to stimulate efficient blending by funneling blend media along a path p extending along the ramps 130, as shown in FIG. 5, toward the planar faces 115 of the blend ribs 110 where blend media is collected and subsequently directed into the spinning blade assembly 120 for processing. Furthermore, the geometry of the ramps 130 is optimized to minimize dead zones throughout the blending container 100 and ensure uniform blending of the blend media despite variations in the volume of blend ingredients or variations in the relative composition of the blend media. The dimensions detailed herein apply to only one non-limiting embodiment, and other dimensions are contemplated and included within the scope of the disclosure.

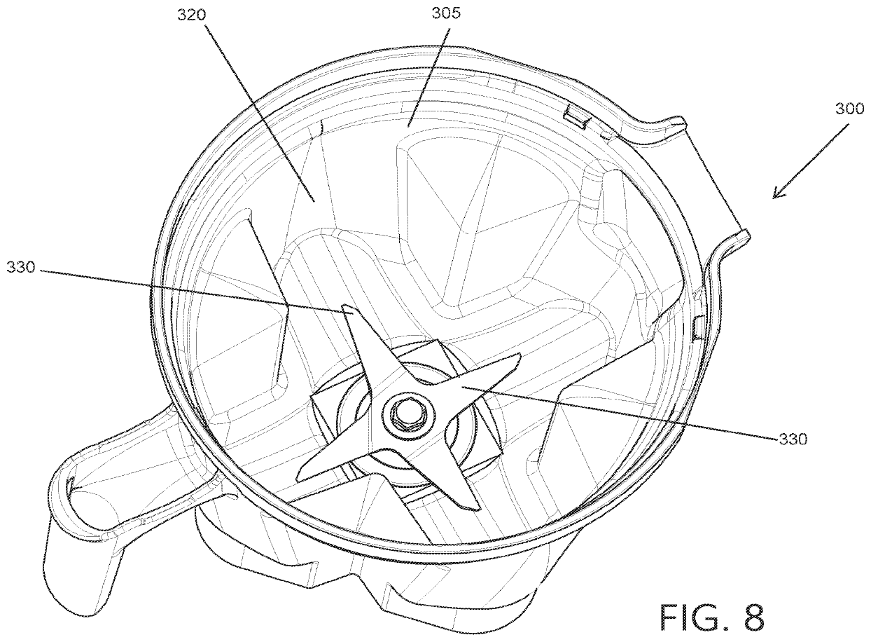

FIGS. 7-9 show blending containers 200, 300, 400. The blending containers 200, 300, 400 include one or more channels 220, 320, 420 defined in the interior wall adjacent one or more ribs, or impingements, 210, 310, 410 and/or in between two or more ribs 210, 310, 410. The channels 220, 320, 420 are sunken relative to the surrounding ribs 210, 310, 410. In various instances, the blending containers 200, 300, 400 may include ribs 210, 310, 410 that extend closer toward into a center c of the container 200, 300, 400 at their lower portions. Stated another way, the blending containers 200, 300, 400 may include ribs 210, 310, 410 that are tapered projections. In such instances, the one or more ribs 210, 310, 410 project from an interior wall 205, 305, 405 to different distances toward a center of the blending container 200, 300, 400. In some instances, the ribs 210, 310, 410 extend closer to a center of the blending container 200, 300, 400 near a bottom surface of the blending container than near a top opening of the container. As shown in FIGS. 7-9, the blending containers 200, 300, 400 may include four ribs 210, 310, 410 spaced equidistant about an interior wall 205, 305, 405 of the blending containers 200, 300, 400, providing four channels 220, 320, 420 in between the four ribs 210, 310, 410. It is noted that other suitable quantities of ribs and channels are also contemplated herein as well as different and/or varied spacing about the interior wall of the blending containers.

In an embodiment, the described blending containers 200, 300, 400 shown in FIGS. 7-9 may have the following measurements. It is noted that each of the measurements may separately be in a range of +/−0.5″ of the following measurements. When a blade is aligned with a rib 210, the distance between a flat, 0° angle blade tip 235 and a rib 210 can be 0.15″. When a blade is aligned with a channel 220, the distance between the flat, 0° blade tip 235 to a deepest point of the channel 220 between the ribs 210 can be 1.1″. The channel 220 has varying widths. Stated another way, a first portion of the channel 220 positioned near to the blade 230 is wider than a second portion of the channel 220 positioned further from the blade 230. In such instances, the width of the first portion W_{c,1} can be 2.56″ while the width of the second portion W_{c,2} can be 2.27″. An internal dimension of ribs 210 at blade height can be 3.28″ while an internal dimension of ribs at an end of the rib nearest an open end of the container can be 3.45″.

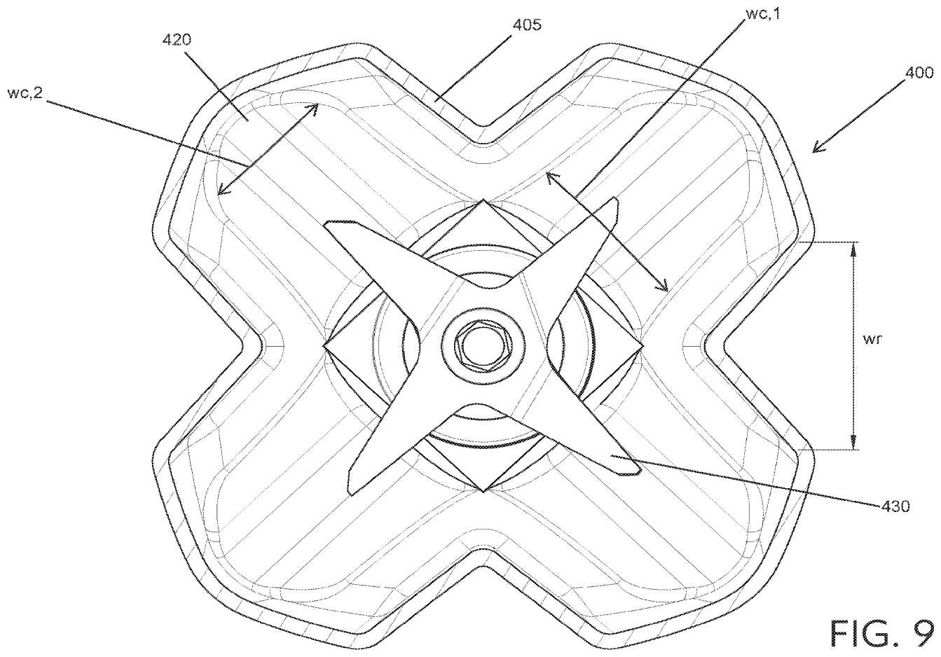

FIGS. 7-9 show blending containers 200, 300, 400. In an example, FIGS. 8 and 9 depict a size or dimension of the rib 310, 410 at a point in line with a height of the blade 330, 430. Stated another way, FIGS. 8 and 9 illustrate a dimension that the rib 310, 410 protrudes toward a center and/or midpoint of the blending container at a blade height. Such thickness is measured from the inside point of the rib to where the rib joins the wall inside the channel and, in at least one example, is 0.95″. The same measurement for the blending container 200 in FIG. 7 may be 0.3″. Stated another way, the ribs 310, 410 depicted in FIGS. 8 and 9 protrude deeper into the blending container 300, 400 and/or protrude closer toward a center of the blending container 300, 400 than the ribs 210 depicted in FIG. 7. The thicker ribs 310, 410 in FIGS. 8 and 9, as opposed to the thinner ribs 210 depicted in FIG. 7, may correspondingly form deeper channels 320, 420 in between and defined by the ribs 310, 410. As shown in FIG. 8, the ribs 310 may be formed within and/or extend from a generally circular and/or oval blending container 300, e.g., a blending container having a generally cylindrical, circular, and/or oval external profile and sidewalls. As shown in FIG. 9, the ribs 410 may be formed as part of a cut-in on the blending container 400, e.g., a blending container having an external profile and an interior wall 405 that have cut-ins corresponding to the internal ribs 410. In such instances, a thickness of the interior wall 405 is uniform. In an embodiment, blending containers 300, 400 may have generally the same or similar interior geometry and the internal ribs 310, 410 may generally operate the same or similarly in both blending containers 300, 400, but the interior wall of the blending containers 300, 400 from an external perspective may be different. Stated another way, while the interiors of both blending containers 300, 400 may look substantially identical, the exterior profiles of both blending containers 300, 400 may look different due at least in part to the method of formation of the internal ribs 310, 410. In various instances, it may be desirable from a cost perspective, for example, to minimize the amount of material needed to manufacture the blending container. In other instances, it may be desirable from a durability perspective, for example, to maximize the thickness of sidewalls of the blending container.

In an example, using conventional blending containers and systems, when blending processes are undertaken to process ingredients to a smooth uniform finished product with high speeds, the ingredients may be thrown by the blade to a location where the ingredients end up out of reach of the blade for a notable part of the blend time. As the blending device can only cut at the ingredients when they fall back into, or otherwise come into contact with, the blades from the top of the blending container, conventional blending containers and systems fail to provide efficient and/or effective solutions.

The described blending containers may prevent or minimize ingredients being thrown out of reach of the blade during blending processes.

In an example, impingements/ribs may be generally used to push ingredients from a top section of the blending container back into and/or toward a bottom, or base surface, of the blending container. Stated another way, the ingredients are pushed from the top section of the blending container back into interaction with a blade assembly positioned near a base of the blending container. Conventional impingements/ribs may be less pronounced at the bottom of the container and become more pronounced at the upper portion of the container. The presence of more pronounced impingements/ribs at the upper portion of the blending container may lead to the blended contents becoming stuck in an upper portion of the blending container out of reach of the blade assembly. Conventional blending containers and systems further may include ribbed blending containers or those that use harsh, or blunt shapes such as a triangle advance design or a square blending container. While the blunt 90 degree wall in these designs may motivate ingredients back toward a center of the blending container, such designs may force a blending system to use a lower speed initially followed by several different speeds to achieve the desired finished product in an effort to be efficient in a time period needed to process the recipe, for example.

The described blending containers having an alternating rib and deep channel design pronounced at least in a bottom portion of the blending container may allow for the immediate use of high speed and may reduce product flying into the upper portion of the blending container. In an embodiment, as the foodstuff is blending, e.g., when the ice and liquids are hit by the blades, the blade begins to break the foodstuff down. The force of the blade assembly directs the foodstuff into the deep chambers, or channels, of the blending container. The channels of the blending container may stop the foodstuff from moving vertically out of contact and/or reach of the blade assembly and instead direct the foodstuff back into the blade assembly for more refined processing.

In an example, a conventional blade may initially strike the foodstuff to begin blending the foodstuff. The strike of the conventional blade may cause the foodstuff to slam into the, for example, 90 degree wall of the blending container which can then create back pressure on the blade. Such back pressure on the blade in turn creates a notable, undesirable load on the motor. In an example, the load experienced in a conventional blending container may slow the motor down as it draws more power from the outlet to fight back up to the desired speed setting.

The described blending containers may provide an efficient use of energy. By comparison to conventional blending containers, the described blending containers may draw less or a very similar amount of power rather than requiring more power to process and/or blend foodstuff faster. The described blending containers may achieve higher speeds which may help processing and blending because the blades are not processing the entire recipe at the same time in the blend zone (immediate area of the blades). Stated another way, the channels serve to rotate portions of the recipe in and out of the blend zone during the blending process. As such, the deep channels of the blending container may not add as significant of a load to the blades which would otherwise translate to load on the motor. The reduction in load on the motor in the described containers may allow the motor to maintain speed better and thus draw less power.

In an example, an increased load on the motor can also create heat. The production of heat may be undesirable for motor life, may increase power consumption, and/or may negatively impact life of the brush, motor, and blending device. In an example, a higher power consumption corresponds to a shortened brush life. Brush life is generally the most prominent cause of failure in an AC motor. Brushes of a motor may be considered a consumable part of the motor and once the brush wears out the motor may no longer be operable.

The described blending containers may improve the life of the motor and may be less likely to overheat as an efficient flow path is created using the channels and/or ribs defined on an interior wall of the blending container. Such a definition of an efficient flow path alleviates a burden on the motor, as the blades are not processing the entire blended recipe at one time. Additionally, such an interior geometry having one or more ribs and channels alleviates the backpressure on the blade of conventional blending containers.

What has been described herein includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define the blending system. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While particular aspects have been illustrated and described herein, it should be understood that various other changes and modifications may be made without departing from the spirit and scope of the claimed subject matter. Although various aspects of the claimed subject matter have been described herein, such aspects need not be utilized in combination. It is therefore intended that the appended claims cover all such changes and modifications that are within the scope of the claimed subject matter.

### EXAMPLES

A blending container comprising a body and a blade assembly coupled to the body is disclosed. The body comprises a first end defining an opening, a second end defining a base, and an interior wall extending between the first end and the second end. The body further comprises a rib projecting toward a center of the blending container, the rib extending a first length of the interior wall from the base toward the first end, a channel defined in the interior wall adjacent the first rib, and a ramp extending between the base and the channel defined by the interior wall. The blade assembly is positioned at a blade height from the base of the body, and the ramp is shaped to minimize a distance between the body and a surface of the blade assembly facing the base.

The blending container according to any one of the previous examples, wherein the blade assembly is removably coupled to the body.

The blending container according to any one of the previous examples, wherein the ramp comprises a concave shape.

The blending container according to any one of the previous examples, wherein the ramp comprises a first slope at a first point adjacent the interior wall and a second slope at a second point adjacent the base, the first slope being greater than the second slope.

The blending container according to any one of the previous examples, wherein a distance the rib projects toward the center of the blending container tapers along a vertical length.

The blending container according to any one of the previous examples, wherein a distance the rib projects toward the center of the blending container is greatest at a point on the rib corresponding to the blade height.

The blending container according to any one of the previous examples, wherein the rib extends a length along the interior wall of the body, wherein the interior wall extends an interior wall length from the first end to the second end, and wherein the interior wall length is greater than the length.

The blending container according to any one of the previous examples, wherein the rib is defined along the interior wall from the base toward the first end of the body.

The blending container according to any one of the previous examples, wherein the interior wall of the body comprises a uniform thickness.

The blending container according to any one of the previous examples, wherein an external profile of the body corresponds to the rib and the channel.

The blending container according to any one of the previous examples, further comprising a plurality of ribs spaced equidistantly around the interior wall of the body.

A blending system comprising a base, a blending container removably coupled to the base, and a blade assembly coupled to the body is disclosed. The blending container comprises a body comprising a first end defining an opening, a second end defining a bottom surface, and an interior wall extending between the first end and the second end. The body further comprises a rib projecting from the interior wall toward a center of the blending container, a channel defined in the interior wall adjacent the rib, and a ramp extending between the bottom surface and the channel defined in the interior wall. The blade assembly is coupled to the body at a blade height from the bottom surface of the body.

The blending system according to any one of the previous examples, wherein the base comprises a motor.

The blending system according to any one of the previous examples, wherein the blade assembly is rotatably driven by the motor.

The blending system according to any one of the previous examples, wherein the blade assembly is removably coupled to the body.

The blending system according to any one of the previous examples, wherein the ramp comprises a concave shape.

The blending system according to any one of the previous examples, wherein the ramp comprises a first slope at a first point adjacent the interior wall and a second slope at a second point adjacent the bottom surface, the first slope being greater than the second slope.

The blending system according to any one of the previous examples, wherein a distance the rib projects toward the center of the blending container tapers along a vertical length.

The blending system according to any one of the previous examples, wherein a distance the rib projects toward the center of the blending container is greatest at a point on the rib corresponding to the blade height.

The blending system according to any one of the previous examples, wherein the rib extends a length along the interior wall of the body, wherein the interior wall extends an interior wall length from the first end to the second end, and wherein the interior wall length is greater than the length.

The blending system according to any one of the previous examples, wherein the rib is defined along the interior wall from the bottom surface toward the first end of the body.

The blending system according to any one of the previous examples, wherein the interior wall of the body comprises a uniform thickness.

The blending system according to any one of the previous examples, wherein an external profile of the body corresponds to the rib and the channel.

The blending system according to any one of the previous examples, further comprising a plurality of ribs spaced equidistantly around the interior wall of the body.

The blending system according to any one of the previous examples, wherein the blending container comprises the blade assembly.

1. A blending container, comprising:
a body, comprising:
a first end defining an opening;
a second end defining a bottom surface;
an interior wall extending between the first end and the second end;
a rib projecting toward a center of the blending container, the rib extending a length of the interior wall from the bottom surface toward the first end;
a channel defined in the interior wall adjacent the rib; and
a ramp extending between the bottom surface and the channel defined by the interior wall; and
a blade assembly coupled to the body and positioned at a blade height from the bottom surface of the body, the ramp shaped to minimize a distance between the body and a surface of the blade assembly facing the bottom surface.

2. The blending container according to claim 1, wherein the blade assembly is removably coupled to the body.

3. The blending container according to claim 1, wherein the ramp comprises a concave shape.

4. The blending container according to claim 1, wherein the ramp comprises a first slope at a first point adjacent the interior wall and a second slope at a second point adjacent the bottom surface, the first slope being greater than the second slope.

5. The blending container according to claim 1, wherein a distance the rib projects toward the center of the blending container tapers along a vertical length.

6. The blending container according to claim 1, wherein a distance the rib projects toward the center of the blending container is greatest at a point on the rib corresponding to the blade height.

7. The blending container according to claim 1, wherein the rib extends a length along the interior wall of the body, wherein the interior wall extends an interior wall length from the first end to the second end, and wherein the interior wall length is greater than the length.

8. The blending container according to claim 1, wherein the rib is defined along the interior wall from the base toward the first end of the body.

9. The blending container according to claim 1, wherein the interior wall of the body comprises a uniform thickness.

10. The blending container according to claim 1, wherein an external profile of the body corresponds to the rib and the channel.

11. The blending container according to claim 1, further comprising a plurality of ribs spaced equidistantly around the interior wall of the body.

12. A blending system, comprising:
a base;
a blending container removably coupled to the base, the blending container comprising:
a body, comprising:
a first end defining an opening;
a second end defining a bottom surface;
an interior wall extending between the first end and the second end;
a rib projecting from the interior wall toward a center of the blending container;
a channel defined in the interior wall adjacent the rib; and
a ramp extending between the bottom surface and the channel defined in the interior wall; and
a blade assembly coupled to the body at a blade height from the bottom surface of the body.

13. The blending system according to claim 12, wherein the base comprises a motor.

14. The blending system according to claim 13, wherein the blade assembly is rotatably driven by the motor.

15. The blending system according to claim 12, wherein the blade assembly is removably coupled to the body.

16. The blending system according to claim 12, wherein the ramp comprises a concave shape.

17. The blending system according to claim 12, wherein the ramp comprises a first slope at a first point adjacent the interior wall and a second slope at a second point adjacent the bottom surface, the first slope being greater than the second slope.

18. The blending system according to claim 12, wherein a distance the rib projects toward the center of the blending container tapers along a vertical length.

19. The blending system according to claim 12, wherein a distance the rib projects toward the center of the blending container is greatest at a point on the rib corresponding to the blade height.

20. The blending system according to claim 12, wherein the rib extends a length along the interior wall of the body, wherein the interior wall extends an interior wall length from the first end to the second end, and wherein the interior wall length is greater than the length.

21.-25. (canceled)
